(19) United States
(12) Patent Application Publication
(10) Pub. No.: US 2011/0026123 A1
(43) Pub. Date: Feb. 3, 2011

(54) WAVELENGTH-DIVISION APPARATUS AND WAVELENGTH COMBINING APPARATUS

(75) Inventors: Joon-ki LEE, Daejeon-si (KR); Sae-kyoung KANG, Daejeon-si (KR); Jyung-chan LEE, Daejeon-si (KR); Kwang-joon KIM, Daejeon-si (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejeon-si (KR)

(21) Appl. No.: 12/773,129

(22) Filed: May 4, 2010

(30) Foreign Application Priority Data
Jul. 30, 2009 (KR) 10-2009-0070043

(51) Int. Cl. G02B 5/28

(52) U.S. Cl. 359/590

(57) ABSTRACT

A wavelength-division apparatus and a wavelength combining apparatus are provided. Each of the wavelength-division apparatus and the wavelength combining apparatus includes a transparent block having one surface which is coated with an anti-reflective coating layer and the other surface which is coated with a partial transmitting coating layer. Each of the anti-reflective coating layer and the partial transmitting coating layer is coupled to a plurality of wavelength-selective filters that separate optical signals of different wavelengths through different paths other than a transmission path or a receiving path. Thus, the optical signals of the respective wavelengths output through the different paths can be used for various purposes such as monitoring the signal intensity and/or the signal quality.

### CROSS REFERENCE TO RELATED APPLICATION

This application claims the benefit under 35 U.S.C. §119(a) of Korean Patent Application No. 10-2009-0070043, filed on Jul. 30, 2009, the entire disclosure of which is incorporated herein by reference for all purposes.

### BACKGROUND

1. Field

The following description relates to technology of wavelength multiplexing and demultiplexing, and more particularly, to a wavelength-division apparatus and a wavelength combining apparatus, each of which divides optical signals of one or more wavelength through different paths other than a transmission path or a receiving path of the optical signal.

2. Description of the Related Art

In optical communications, wavelength division multiplexing (WDM) is a technology that multiplexes optical signals having different wavelengths and transmits the multiplexed optical signals on a single optical fiber so as to increase transmission capacity.

In WDM scheme, a wavelength selective element such as a thin film is used to multiplex and demultiplex signals having different wavelengths.

An image processing apparatus adopts a structure that allows signals of a specific wavelength corresponding to a specific color (e.g. red, blue, and green) of an image selectively to pass through and to reflect signals having the other wavelengths.

FIG. 1 illustrates an example of a conventional wavelength-division apparatus. Referring to FIG. 1, when optical signals of different wavelengths are input through one path, a plurality of wavelength-selective elements, each of which is installed at an angle of 45 degrees from the horizontal, reflect optical signals of corresponding wavelengths. The reflected optical signal of a corresponding wavelength is output, and optical signals of the other wavelengths are allowed to pass through each of the wavelength-selective elements, thereby the optical signals are separated according to wavelength.

However, as illustrated in FIG. 1, since the conventional wavelength-division apparatus outputs optical signals through a single path according to their wavelength, optical signals of different wavelengths cannot be separated into different paths.

FIG. 2 illustrates an example of a conventional wavelength combining apparatus. Referring to FIG. 2, optical signals having different wavelengths are incident into one side of the apparatus at predetermined intervals, and then they are reflected on a mirror on the opposite side and the reflected optical signals are combined and simultaneously transmitted in the same direction.

However, since the conventional wavelength combining apparatus as shown in FIG. 2 combines the optical signals having different wavelengths and outputs the combined optical signal through a single path, the optical signals having different wavelengths cannot be separated into different paths.

Thus, there has been a need of a technology that separates optical signals of different wavelengths through different paths when the optical signals are multiplexed or demultiplexed such that the separated optical signals of corresponding wavelengths can be used for various purposes such as monitoring the signal intensity and/or the signal quality.

### SUMMARY

Accordingly, provided are a wavelength-division apparatus and a wavelength combining apparatus suitable to optical signal multiplexing and demultiplexing. The wavelength-division apparatus and the wavelength combining apparatus are able to separate optical signals having different wavelengths through different paths.

In one general aspect, provided is a wavelength-division apparatus including a transparent block having one surface which is coated with an anti-reflective coating layer and the other surface which is coated with a partial transmitting coating layer, wherein each of the anti-reflective coating layer and the partial transmitting coating layer is coupled to a plurality of wavelength-selective filters that separate optical signals of different wavelengths through different paths.

In another general aspect, provided is a wavelength combining apparatus including a transparent block having one surface which is coated with an anti-reflective coating layer and the other surface which is coated with a partial transmitting coating layer, wherein each of the anti-reflective coating layer and the partial transmitting coating layer is coupled to a plurality of wavelength-selective filters that separate optical signals of different wavelengths through different paths.

Other features and aspects will be apparent from the following detailed description, the drawings, and the claims.

### BRIEF DESCRIPTION OF THE DRAWINGS

FIG. 1 is a diagram illustrating an example of a conventional wavelength-division apparatus.

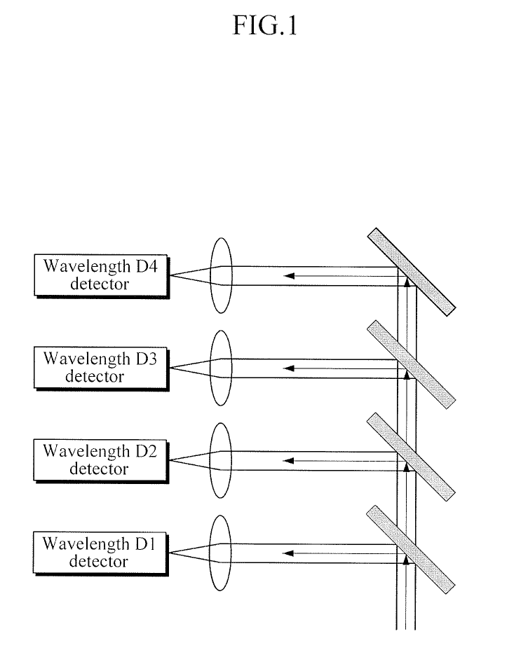

FIG. 2 is a diagram illustrating an example of a conventional wavelength combining apparatus.

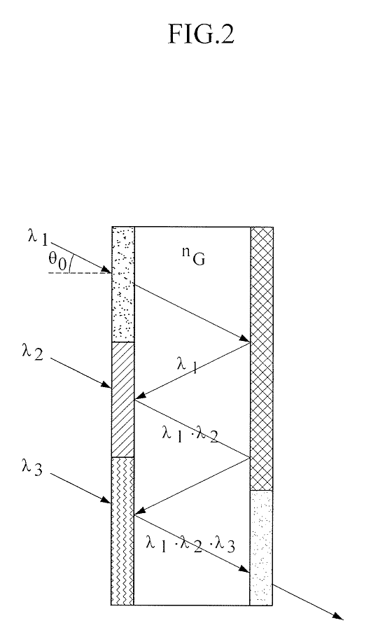

FIG. 3 is a cross-sectional view of an example of a wavelength-division apparatus.

FIG. 4 is a cross-sectional view of another example of a wavelength-division apparatus.

FIG. 5 is a cross-sectional view of an example of a wavelength combining apparatus.

FIG. 6 is a cross-sectional view of another example of a wavelength combining apparatus.

Throughout the drawings and the description, unless otherwise described, the same drawing reference numerals are understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

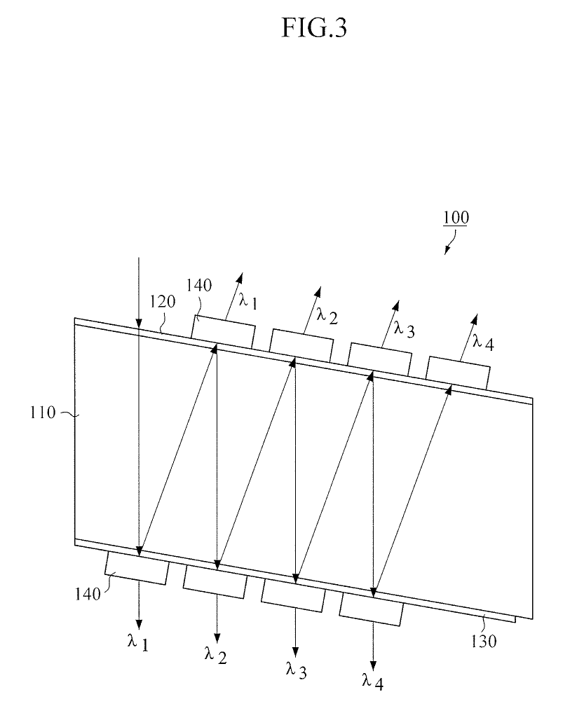

FIG. 3 illustrates a cross-sectional view of an example of a wavelength-division apparatus 100. Referring to FIG. 3, the wavelength-division apparatus 100 includes a transparent block 110, an anti-reflective coating layer 120, a partial transmitting coating layer 130, and a plurality of wavelength-selective filters 140.

The transparent block 110 is formed of a transparent material and has one surface coated with the anti-reflective coating layer 120 and the other surface coated with the partial transmitting coating layer 130. The transparent block 110 may be formed such that the anti-reflective coating layer 120 and the partial transmitting coating layer 130 are inclined at a predetermined angle with respect to a vertical direction.

The anti-reflective coating layer 120 is coated on one surface of the transparent block 110, and does not reflect but transmit all light. The partial transmitting coating layer 130 is coated on the other surface of the transparent block 110, and transmits some light and reflects the rest.

The wavelength-selective filters 140 are respectively coupled to the anti-reflective coating layer 120 and the partial transmitting coating layer 130. Each wavelength-selective filter 140 transmits light of a specific wavelength, while reflecting light of the other wavelengths. The wavelength-selective filters 140 may include at least two pairs of wavelength-selective filters, wherein the paired wavelength-selective filters 140 filter light of the same wavelength and the respective pairs of the wavelength-selective filters respectively filter light of different wavelengths.

As shown in FIG. 3, the wavelength-selective filters 140 may be disposed in an alternating manner on both the anti-reflective coating layer 120 and the partial transmitting coating layer 130 such that light reflected by each of the wavelength-selective filters 140 is input to the alternating wavelength-selective filter 140 on the opposite surface of the transparent block 110.

When incident light having different wavelengths combined together is incident to the anti-reflective coating layer 120 coated on one surface of the transparent block 110, the incident light passes through the anti-reflective coating layer 120 and the transparent block 110. The light passing through the transparent block 110 is incident to the partial transmitting coating layer 130 formed on the other surface of the transparent block 110.

The partial transmitting layer 130 which is inclined at a predetermined angle with respect to a vertical direction allows some of the incident light to pass therethrough and reflects the rest at a predetermined angle. The light passing through the partial transmitting layer 130 is filtered by the wavelength-selective filter 140 which is coupled to a portion of the partial transmitting layer 130 through which the light passes, and the filtered light of a specific wavelength is selectively output.

The light reflected by the partial transmitting coating layer 130 at the predetermined angle passes through the transparent block 110 and is incident to the anti-reflective coating layer 120 which allows the incident light to passes therethrough. The light passing through the anti-reflective coating layer 120 is filtered by the wavelength-selective filter 140 which is coupled to the anti-reflective coating layer 120 and positioned at an area where the light passes through the anti-reflective coating layer 120, and the filtered of a specific wavelength is selectively output.

In the above example, if each of the wavelength-selective filters 140 coupled to the partial transmitting coating layer 130 is paired with each of the wavelength-selective filters 140 coupled to the anti-reflective coating layer 120 so as to filter light of the same wavelength and a plurality of pairs of wavelength-selective filters 140, which respectively filter light of different wavelengths, are disposed predetermined distances apart from one another, light of respective different wavelengths (λ₁, λ₂, λ₃, and λ₄) may be separated through more than two paths as shown in FIG. 3.

Accordingly, when optical signals are demultiplexed, the optical signals of different wavelengths can be separated and output respectively through different paths other than a receiving path, and thus the optical signals of one or more wavelengths output through the receiving path may only be used as receiving signals, and the optical signals of the respective wavelengths output through the different paths other than the receiving path may be used for various purposes such as monitoring the signal intensity and/or the signal quality.

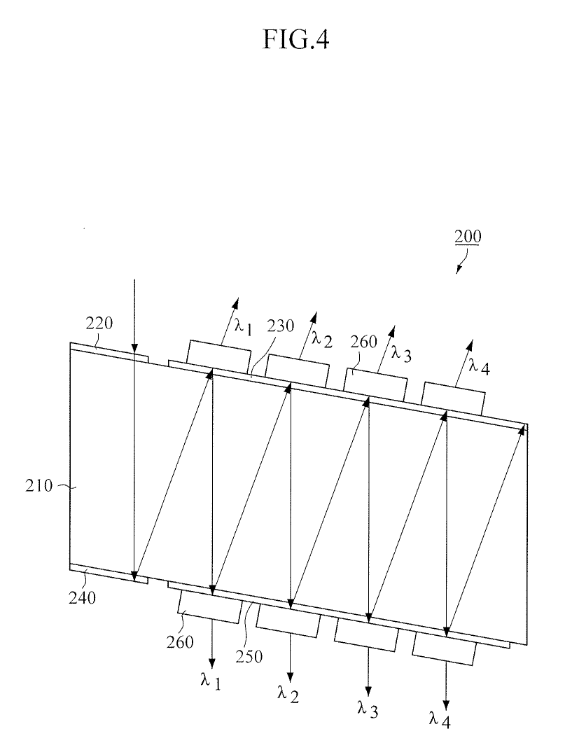

FIG. 4 illustrates a cross-sectional view of another example of a wavelength-division apparatus 200. Referring to FIG. 4, the wavelength-division apparatus 200 includes a transparent block 210, a first anti-reflective coating layer 220, a partial transmitting coating layer 230, a full-reflective coating layer 240, a second anti-reflective coating layer 250, and a plurality of wavelength-selective filters 260.

The transparent block 210 is made of a transparent material, and has one surface coated with the first anti-reflective coating layer 220 and the partial transmitting coating layer 230 which are disposed a predetermined distance apart from each other, and the other surface coated with the full-reflective coating layer 240 and the second anti-reflective coating layer 250 which are disposed a predetermined distance apart from each other. The both surfaces of the transparent block 210 may be configured to be inclined at a predetermined angle with respect to a vertical direction.

The first anti-reflective coating layer 220 is coated on a region of one surface of the transparent block 210, and does not reflect but transmits all incident light. The partial transmitting coating layer 230 is coated on a region of the surface of the transparent block 210, while being spaced a predetermined distance from the first anti-reflective coating layer 220. The partial transmitting coating layer transmits some light and reflects the rest.

The full-reflective coating layer 240 is coated on a region of the other surface of the transparent block 210, and reflects all incident light. The second anti-reflective coating layer 250 is coated on a region of the surface of the transparent block 210, while being spaced a predetermined distance from the second full-reflective coating layer 240. The second anti-reflective coating layer 250 does not reflect but transmits all incident light.

The wavelength-selective filters 260 are respectively coupled to the partial transmitting coating layer 230 and the second anti-reflective coating layer 250. Each wavelength-selective filter 260 transmits light of a specific wavelength, while reflecting light of the other wavelengths. The wavelength-selective filters 260 may be configured to include at least two pairs of wavelength-selective filters, wherein the paired wavelength-selective filters 260 filter light of the same wavelength and the respective pairs of the wavelength-selective filters 260 respectively filter light of different wavelengths.

The wavelength-selective filters 260 are disposed on both the partial transmitting coating layer 230 and the second anti-reflective coating layer 250 such that they can face each other, and thus light reflected by one wavelength-selective filter 260 is incident to an opposite facing wavelength-selective filter 260.

Consequently, when light having different wavelengths combined is incident to the first anti-reflective coating layer 220 coated on one surface of the transparent block 210, the incident light passes through the first anti-reflective coating layer 220 and the transparent block 210. The incident light passing through the transparent block 210 is incident to the full-reflective coating layer 240 formed on the other surface of the transparent block 210.

The full-reflective coating layer 240 which is inclined at a predetermined angle reflects the all incident light at a predetermined angle. Some of the light reflected by the full-reflective coating layer 240 passes through the transparent block 210 and the partial transmitting coating layer 230, and the rest of the reflected light is reflected by the partial transmitting coating layer 230.

The light passing through the partial transmitting coating layer 230 is filtered by the wavelength-selective filter 260 that is coupled to a portion of the partial transmitting coating layer 230 through which the light passes, and light of a specific wavelength is selectively output.

The light reflected by the partial transmitting coating layer 230 at the predetermined angle passes through the transparent block 210, and then is incident to the second anti-reflective coating layer 250 on the opposite surface of the transparent block 250. The second anti-reflective coating layer 250 passes the incident light therethrough. The light passing through the second anti-reflective coating layer 250 is filtered by the wavelength-selective filter 260 that is coupled to a portion of the second anti-reflective coating layer 250 through which the light passes, and light of a specific wavelength is selectively output.

When the wavelength-selective filters 260 coupled to the partial transmitting coating layer 230 are respectively paired with the facing wavelength-selective filters 260 coupled to the second anti-reflective coating layer 250 such that the paired wavelength-selective filters 260 filter light of the same wavelength and when a plurality of pairs of facing wavelength-selective filters 260, which respectively filter light of different wavelengths, are disposed predetermined distances apart from one another, light of respective different wavelengths (λ₁, λ₂, λ₃, and λ₄) can be separated through more than two different paths.

Accordingly, when optical signals of different wavelengths are demultiplexed, the optical signals of different wavelengths can be separated and output through different paths other than a receiving path. Hence, optical signals of different wavelengths output through the receiving path may only be used as receiving signals and the optical signals of the respective wavelengths output through the different paths other than the receiving path may be used for various purposes such as monitoring the signal intensity and/or the signal quality.

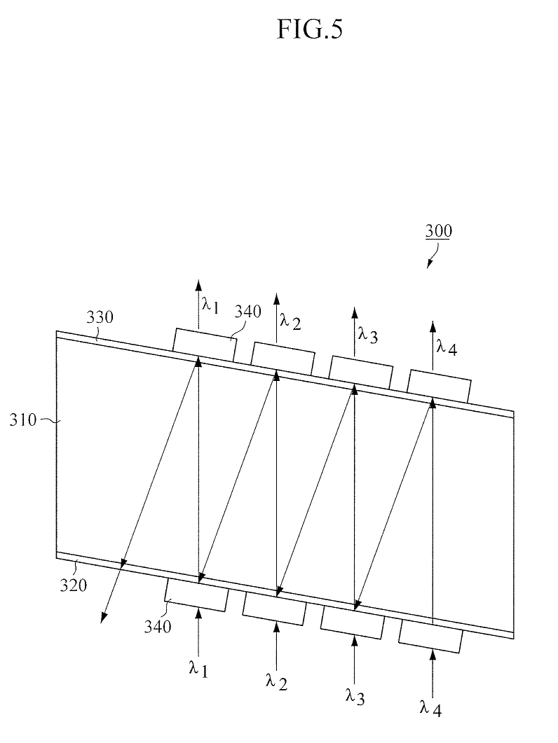

FIG. 5 illustrates a cross-sectional view of an example of a wavelength combining apparatus 300. Referring to FIG. 5, the wavelength combining apparatus 300 includes a transparent block 310, an anti-reflective coating layer 320, a partial transmitting coating layer 330, and a plurality of wavelength-selective filters 340.

The transparent block 310 is formed of a transparent material, and has one surface coated with the anti-reflective coating layer 320 and the other surface coated with the partial transmitting coating layer 330. The anti-reflective coating layer 320 and the partial transmitting coating layer 330 may be inclined at a predetermined angle with respect to a vertical direction.

The anti-reflective coating layer 320 is coated on one surface of the transparent block 310, and does not reflect, but transmits light. The partial transmitting coating layer 330 is coated on the other surface of the transparent block 310, transmits some light, and reflects the rest.

The plurality of wavelength-selective filters 340 are respectively coupled to the anti-reflective coating layer 320 and the partial transmitting coating layer 330. Each wavelength-selective filter 340 transmits light of a specific wavelength, while reflecting light of the other wavelengths. The wavelength-selective filters 340 may include at least two pairs of wavelength-selective filters, wherein the paired wavelength-selective filters filter light of the same wavelength and the respective pairs of the wavelength-selective filters filter light of different wavelengths.

As illustrated in FIG. 5, the wavelength-selective filters 340 are disposed on both the partial transmitting coating layer 230 and the second anti-reflective coating layer 250 such that they can face each other, and thus light reflected by one wavelength-selective filter 340 may be incident to an opposite facing wavelength-selective filter 340.

In detail, when light of different wavelengths is input to the respective wavelength-selective filters 340 which are coupled to the anti-reflective coating layer 320 formed on one surface of the transparent block 310, the light of each wavelength passes through the anti-reflective coating layer 320 and the transparent block 310, and is incident to the partial transmitting coating layer 330 formed on the other surface of the transparent block 310.

Some of the light incident to the partial transmitting coating layer 330 which is disposed on one surface of the transparent block 310 at a predetermined angle passes through the partial transmitting coating layer 330, and some of the light is reflected at a predetermined angle. The light passing through the partial transmitting coating layer 330 is filtered by the wavelength-selective filter 340 which is coupled to a portion of the partial transmitting coating layer 330 through which the light passes, and light of a specific wavelength is selectively output.

When each of the wavelength-selective filter 340 coupled to the partial transmitting coating layer 330 may be configured to be paired with an opposite facing wavelength-selective filter 340 coupled to the anti-reflective coating layer 320 such that the paired the wavelength-selective filters 340 filter light of the same wavelength and when a plurality of pairs of the facing wavelength-selective filters 340 that respectively filter light of corresponding wavelengths are configured to be spaced predetermined distances apart from one another, light of different wavelength (λ₁, λ₂, λ₃, and λ₄) can be separated through more than two paths other than a transmission path.

The light reflected by the partial transmitting coating layer 330 at the predetermined angle passes through the transparent block 310 via the same transmission path. The light passing through the transparent block 310 are incident to the anti-reflective coating layer 320 formed on one surface of the transparent block 310 and are reflected by the wavelength-selective filters 340. The reflected light of different wavelengths is combined into a single optical signal and the optical signal is finally output through the anti-reflective coating layer 320.

As such, when optical signals are multiplexed, the optical signals of different wavelengths are separated and output through different paths other than a transmission path. Hence, a wavelength-combined optical signal output through the transmission path may only be used as a transmission signal and optical signals of the respective wavelengths output through different paths other than the transmission path may be used for various purposes such as monitoring the signal intensity and/or the signal quality.

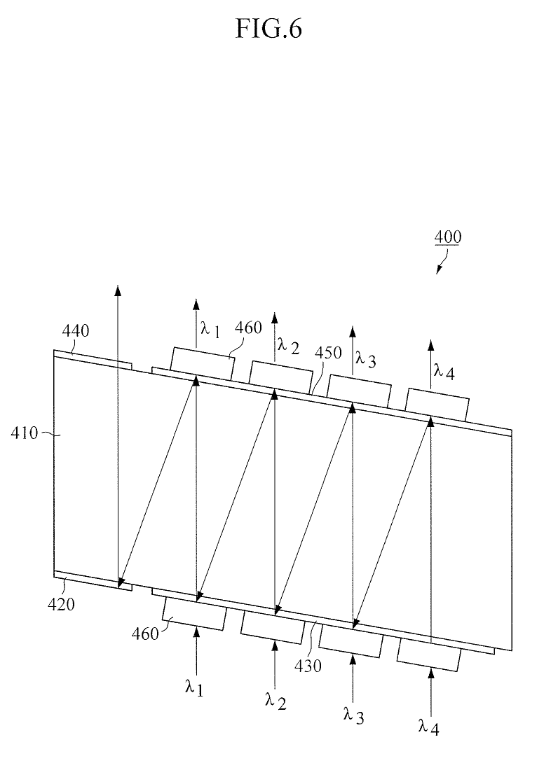

FIG. 6 illustrates a cross-sectional view of another example of a wavelength combining apparatus 400. Referring to FIG. 6, the wavelength combining apparatus 400 includes a transparent block 410, a full-reflective coating layer 420, a first anti-reflective coating layer 430, a second anti-reflective coating layer 440, a partial transmitting coating layer 450, and a plurality of wavelength-selective filters 460.

The transparent block 410 is formed of a transparent material, and has one surface coated with the full-reflective coating layer 420 and the first anti-reflective coating layer 430 which are disposed a predetermined distance apart from each other, and the other surface coated with the second anti-reflective coating layer 440 and the partial transmitting coating layer 450 which are disposed a predetermined distance apart from each other. The both surfaces of the transparent block 410 may be configured to be inclined at a predetermined angle with respect to a vertical direction.

The full-reflective coating layer 420 may be formed to be coated on a region of one surface of the transparent block 410. The full-reflective coating layer 420 reflects all incident light. The first anti-reflective coating layer 430 may be formed to be coated on a region of the surface of the transparent block 410 while being spaced a predetermined distance apart from the full-reflective coating layer 420. The first anti-reflective coating layer 430 does not reflect, but transmits all incident light.

The second anti-reflective coating layer 440 may be formed to be coated on a region of the other surface of the transparent block 410. The second anti-reflective coating layer 440 does not reflect, but transmit all incident light. The partial transmitting coating layer 450 may be formed to be coated on a region of the other surface of the transparent block 410 while being spaced a predetermined distance apart from the second anti-reflective coating layer 440. The partial transmitting coating layer 450 transmits some light and reflects the rest.

The wavelength-selective filters 460 are respectively coupled to the first anti-reflective coating layer 430 and the partial transmitting coating layer 450. Each wavelength-selective filter 460 transmits light of a specific wavelength, while reflecting light of the other wavelengths. In this case, the wavelength-selective filters 460 may be configured to include at least two pairs of wavelength-selective filters 460, wherein the paired wavelength-selective filters 460 filter light of the same wavelength and the respective pairs of the wavelength-selective filters 460 filter light of different wavelengths.

As illustrated in FIG. 6, the wavelength-selective filters 460 may be disposed on both the first anti-reflective coating layer 430 and the partial transmitting coating layer 450 such that they can face each other. Accordingly, light reflected by each wavelength-selective filter 460 is incident to an opposite facing wavelength-selective filter 460.

In detail, when the light of different wavelengths is input to the respective wavelength-selective filters 460 which are coupled to the first anti-reflective coating layer 430 formed on one surface of the transparent block 410, the respective incident light passes through the first anti-reflective coating layer 430 and the transparent block 410. Then, the light is incident to the partial transmitting coating layer 450 formed on the other surface of the transparent block 410.

The partial transmitting coating layer 450 formed on the other surface of the transparent block 410 at a predetermined angle to the horizontal transmits some light incident thereon, and reflects the rest of the light at a predetermined angle. The light passing through the partial transmitting coating layer 450 is filtered by the wavelength-selective filter 460 which is coupled to a portion of the partial transmitting coating layer 450 through which the light passes. Then, light of a specific wavelength is selectively output by the corresponding wavelength-selective filter 460.

When each of the wavelength-selective filter 460 coupled to the partial transmitting coating layer 450 may be configured to be paired with an opposite facing wavelength-selective filter 460 coupled to the first anti-reflective coating layer 430 such that the paired wavelength-selective filters 460 filter light of the same wavelength and when a plurality of pairs of the facing wavelength-selective filters 460 that respectively filter light of corresponding wavelengths are configured to be spaced predetermined distances apart from one another, light of different wavelengths (λ₁, λ₂, λ₃, and λ₄) can be separated through more than two paths other than a transmission path.

The light reflected by the partial transmitting coating layer 450 at a predetermined angle pass through the transparent block 410 via the same transmission path. The full-reflective coating layer 420 formed on one surface of the transparent block 410 reflects the light which has passed through the transparent block 410 and is incident thereon. The light reflected by the full-reflective coating layer 420 passes through the second anti-reflective coating layer 440 formed on the other surface of the transparent block 410. Then, the light of the respective wavelengths is combined to form a single optical signal, and finally the wavelength-combined optical signal is output.

Accordingly, when an optical signal is multiplexed, optical signals of different wavelengths are separated and output through different paths other than a transmission path. Thus, an optical signal of combined wavelengths that is output through the transmission path is used for signal transmission, and the optical signals of different wavelengths that are output through the different paths other than the transmission path are used for various purposes such as monitoring the signal intensity and/or the signal quality.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A wavelength-division apparatus comprising:
a transparent block to transmit light;
an anti-reflective coating layer to be coated on one surface of the transparent block;
a partial transmitting coating layer to be coated on the other surface of the transparent block; and
a plurality of wavelength-selective filters which are respectively coupled to the anti-reflective coating layer and the partial transmitting coating layer, and each of which transmits light of a specific wavelength, while reflecting light of the other wavelengths.

2. The wavelength-division apparatus of claim 1, wherein the wavelength-selective filters include at least two pairs of wavelength-selective filters and the paired wavelength-selective filters filter light of the same wavelength.

3. The wavelength-division apparatus of claim 2, wherein the respective pairs of wavelength-selective filters filter light of different wavelengths.

4. The wavelength-division apparatus of claim 1, wherein the surface of the transparent block which is coated with the anti-reflective coating layer and the other surface of the transparent block which is coated with the partial transmitting coating layer are inclined at a predetermined angle with respect to a vertical direction.

5. The wavelength-division apparatus of claim 1, wherein the wavelength-selective filters are disposed in an alternating manner on both the anti-reflective coating layer and the partial transmitting coating layer.

6. A wavelength-division apparatus comprising:
a transparent block to transmit light;
a first anti-reflective coating layer and a partial transmitting coating layer which are coated on one surface of the transparent block while being spaced a predetermined distance apart from each other;
a full-reflective coating layer and a second anti-reflective coating layer which are coated on the other surface of the transparent block while being spaced a predetermined distance from each other; and
a plurality of wavelength-selective filters which are respectively coupled to the partial transmitting coating layer and the second anti-reflective coating layer, and each of which transmits light of a specific wavelength, while reflecting light of the other wavelengths.

7. The wavelength-division apparatus of claim 6, wherein the wavelength-selective filters include at least two pairs of wavelength-selective filters and the paired wavelength-selective filters filter light of the same wavelength.

8. The wavelength-division apparatus of claim 7, wherein the respective pairs of wavelength-selective filters filter light of different wavelengths.

9. The wavelength-division apparatus of claim 6, wherein the surface of the transparent block which is coated with the partial transmitting coating layer and the other surface of the transparent block which is coated with the second anti-reflective coating layer are inclined at a predetermined angle with respect to a vertical direction.

10. The wavelength-division apparatus of claim 6, wherein the wavelength-selective filters are respectively coupled to the partial transmitting coating layer and the second anti-reflective coating layer while facing one another.

11. A wavelength combining apparatus comprising:
a transparent block to transmit light;
an anti-reflective coating layer to be coated on one surface of the transparent block;
a partial transmitting coating layer to be coated on the other surface of the transparent block; and
a plurality of wavelength-selective filters which are respectively coupled to the anti-reflective coating layer and the partial transmitting coating layer, and each of which transmits is light of a specific wavelength while reflecting light of the other wavelengths.

12. The wavelength combining apparatus of claim 11, wherein the wavelength-selective filters include at least two pairs of wavelength-selective filters and paired wavelength-selective filters filter light of the same wavelength.

13. The wavelength combining apparatus of claim 12, wherein the respective pairs of wavelength-selective filters filter light of different wavelengths.

14. The wavelength combining apparatus of claim 11, wherein the surface of the transparent block which is coated with the anti-reflective coating layer and the other surface of the transparent block which is coated with the partial transmitting coating layer are inclined at a predetermined angle with respect to a vertical direction.

15. The wavelength combining apparatus of claim 11, wherein the wavelength-selective filters are respectively coupled to the anti-reflective coating layer and the partial transmitting coating layer while facing one another.

16. A wavelength combining apparatus comprising:
a transparent block to transmit light;
a full-reflective coating layer and a first anti-reflective coating layer which are coated on one surface of the transparent block while being spaced a predetermined distance apart from each other;
a second anti-reflective coating layer and a partial transmitting coating layer which are coated on the other surface of the transparent block while being spaced a predetermined distance from each other; and
a plurality of wavelength-selective filters which are respectively coupled to the first anti-reflective coating layer and the partial transmitting coating layer, and each of which transmits light of a specific wavelength, while reflecting light of the other wavelengths.

17. The wavelength combining apparatus of claim 16, wherein the wavelength-selective filters include at least two pairs of wavelength-selective filters and the paired wavelength-selective filters filter light of the same wavelength.

18. The wavelength combining apparatus of claim 17, wherein the respective pairs of wavelength-selective filters filter light of different wavelengths.

19. The wavelength combining apparatus of claim 16, wherein the surface of the transparent block which is coated with the first anti-reflective coating layer and the other surface of the transparent block which is coated with the partial transmitting coating layer are inclined at a predetermined angle with respect to a vertical direction.

20. The wavelength combining apparatus of claim 16, wherein the wavelength-selective filters are respectively coupled to the first anti-reflective coating layer and the partial transmitting coating layer while facing one another.
